(19) United States
(12) Patent Application Publication
(10) Pub. No.: US 2015/0108834 A1
(43) Pub. Date: Apr. 23, 2015

(54) ELECTRONIC DEVICE WITH POWER GENERATION MEANS

(71) Applicant: HON HAI PRECISION INDUSTRY CO., LTD., New Taipei (TW)

(72) Inventor: HSIN-CHENG HSU, New Taipei (TW)

(21) Appl. No.: 14/510,668

(22) Filed: Oct. 9, 2014

(30) Foreign Application Priority Data
Oct. 22, 2013 (TW) 102138168

(51) Int. Cl. H02J 7/00; H02J 1/00

(52) U.S. Cl. CPC H02J 7/0052; H02J 7/0042; H02J 1/00; H02J 2007/0059
USPC 307/23; 320/107

(57) ABSTRACT

An electronic device includes an auxiliary battery and an input device. The input device includes a pressing layer and a piezoelectric layer which is located below the pressing layer. The piezoelectric layer is connected to the auxiliary battery. The pressing layer can be pressed to be elastically deformed. The pressing layer and the piezoelectric layer are concurrently deformed to supply current to the auxiliary battery.

### CROSS-REFERENCE TO RELATED APPLICATIONS

This application claims priority to Taiwanese Patent Application No. 102138168 filed on Oct. 22, 2013, the contents of which are incorporated by reference herein.

### FIELD

The subject matter herein generally relates to electronic devices, and more particularly to an electronic device with power generation means.

### BACKGROUND

Electronic devices, especially mobile electronic devices, typically have limited battery life. Improving such limited battery life presents difficult challenges, especially in high performance mobile electronic devices, such as smartphones and tablet devices. Various techniques for improving the limited battery life of mobile electronic devices have been implemented. For example, mobile electronic devices have been configured to use an extended battery, which may be connected to the mobile electronic device. However, such configurations add weight and bulk to the mobile electronic devices.

### BRIEF DESCRIPTION OF THE DRAWINGS

Implementations of the present technology will now be described, by way of example only, with reference to the attached figures.

FIG. 1 is a block diagram view of one embodiment of the structure of an electronic device with power generation means.

FIG. 2 is a block diagram view of an input device of the electronic device of FIG. 1.

FIG. 3 is a flow chart of one embodiment of a method for supplying power to the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising,” when utilized, means “including, but not necessarily limited to”; it specifically indicates open-ended inclusion or membership in the so-described combination, group, series and the like.

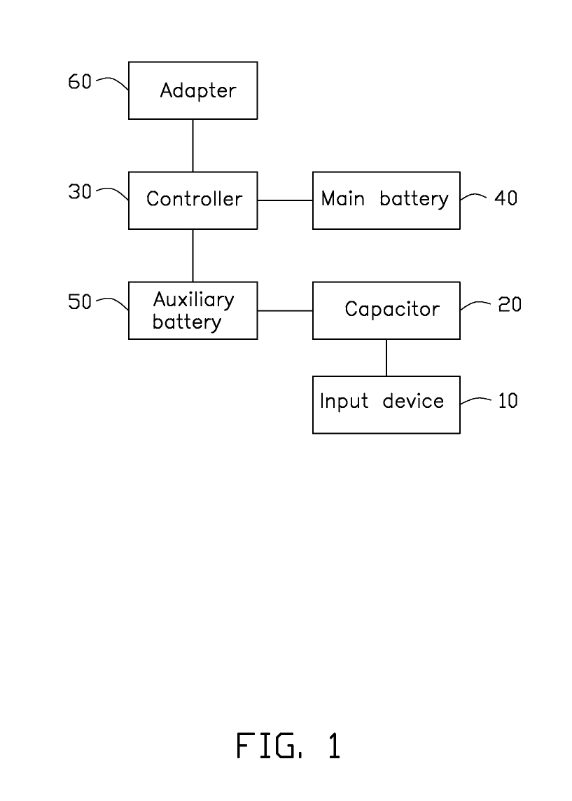

FIG. 1 illustrates one embodiment of an electronic device with power generation means. The electronic device includes an input device 10, a capacitor 20, a controller 30, a main battery 40, an auxiliary battery 50, and an adapter 60.

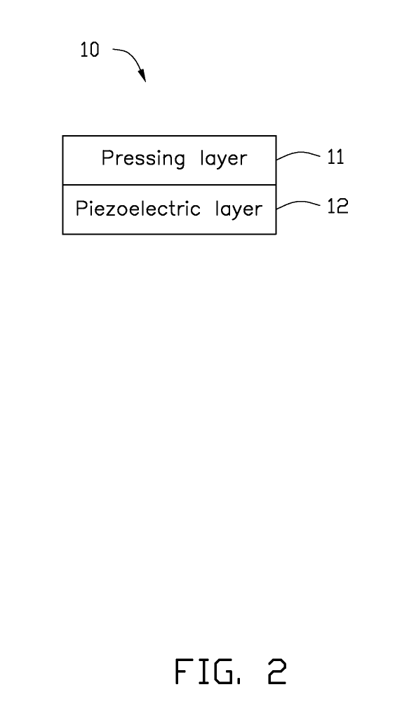

Referring to FIGS. 1 and 2, the input device 10 is connected to the capacitor 20. In one embodiment, the capacitor 20 is a keyboard, a touch screen or a mouse, etc. The input device 10 includes a pressing layer 11 and a piezoelectric layer 12. The piezoelectric layer 12 is connected to the capacitor 20. The piezoelectric layer 12 is made of piezoelectric material. The pressing layer 11 can be keys of the keyboard or the mouse, or a screen of the touch screen. The pressing layer 11 and the piezoelectric layer 12 are secured together. When the pressing layer 11 is pressed to be elastically deformed, the piezoelectric layer 12 is deformed together with the pressing layer 11 to generate current supplied to the capacitor 20. Therefore, electric power generated by the piezoelectric layer 12 is stored in the capacitor 20.

The capacitor 20 is connected to the auxiliary battery 50, and can charge the auxiliary battery 50.

The controller 30 is connected to the main battery 40, the auxiliary battery 50, and the adapter 60. The controller 30 can control the main battery 40, the auxiliary battery 50, and the adapter 60 to supply power.

The adapter 60 is configure to receive an AC power, and converts the AC power in a DC power, which is supplied to the electronic device.

In the above embodiment, the capacitor 20 charges the auxiliary battery 50 when the capacitor 20 is full. In another embodiment, the capacitor 20 charges the auxiliary battery 50 when electric power stored in the auxiliary batter 50 is less than a threshold level. In another more embodiment, the capacitor 20 can be omitted, and the current generated by the piezoelectric layer 12 charges the auxiliary battery 50 directly.

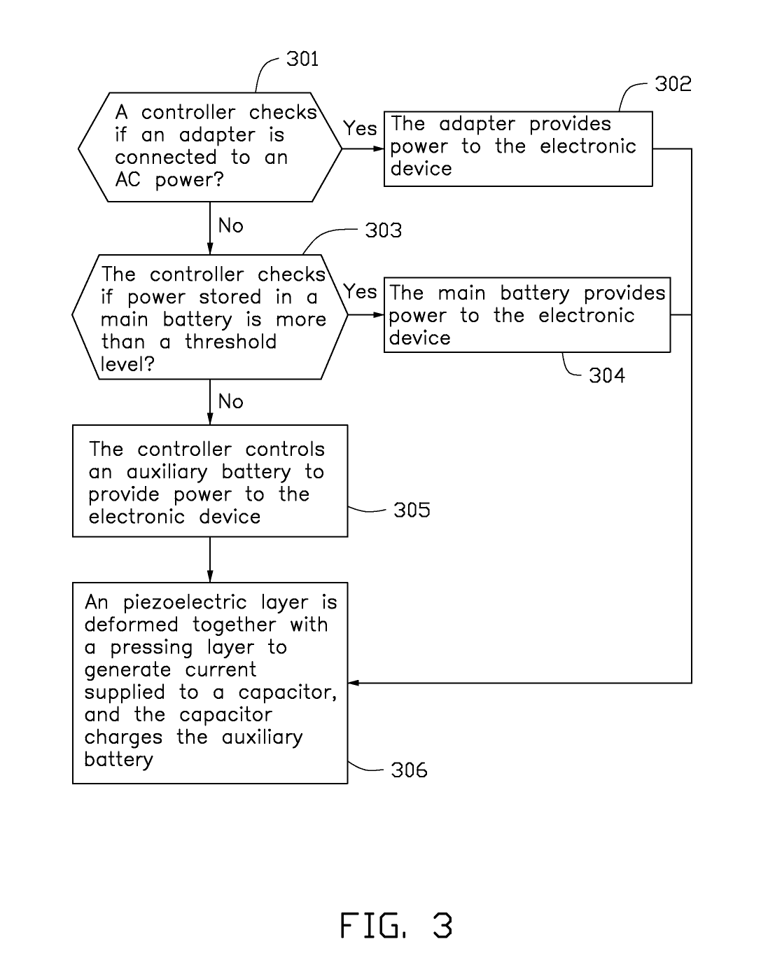

Referring to FIG. 3, a flowchart is presented in accordance with an example embodiment. The example method is provided by way of example, as there are a variety of ways to carry out the method. The method described below can be carried out using the configurations illustrated in FIGS. 1 and 2, for example, and various elements of these figures are referenced in explaining example method. Each block shown in FIG. 3 represents one or more processes, methods, or subroutines carried out in the example method. Furthermore, the illustrated order of blocks is illustrative only and the order of the blocks can change. Additional blocks can be added or fewer blocks can be utilized, without departing from this disclosure. The example method can begin at block 301.

At block 301, a controller checks if an adapter is connected to an AC power.

If yes, go to block 302. If not, go to block 303.

At block 302, the adapter provides power to the electronic device.

At block 303, the controller checks if power stored in a main battery is more than a threshold level. If yes, go to block 304. If not, go to block 305.

At block 304, the main battery provides power to the electronic device.

At block 305, the controller controls an auxiliary battery to provide power to the electronic device. Then, go to block 306.

At block 306, an piezoelectric layer is deformed together with a pressing layer to generate current supplied to a capacitor, and the capacitor charges the auxiliary battery.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device comprising:
an auxiliary battery; and
an input device comprising a pressing layer, and a piezoelectric layer located below the pressing layer and connected to the auxiliary battery;
wherein the pressing layer and the piezoelectric layer are configured to be concurrently deformed to supply current to the auxiliary battery.

2. The electronic device of claim 1, wherein the piezoelectric layer is made of piezoelectric material.

3. The electronic device of claim 1, wherein the input device is a keyboard, and the pressing layer is keys of the keyboard.

4. The electronic device of claim 1, wherein the input device is a touch screen, and the pressing layer is a screen of the touch screen.

5. The electronic device of claim 1, wherein the input device is a mouse, and the pressing layer is a key of the mouse.

6. The electronic device of claim 1, further comprising a capacitor, wherein the capacitor is connected between the piezoelectric layer and the auxiliary battery, and electric energy generated by the piezoelectric layer is stored in the capacitor, and the capacitor charges the auxiliary battery.

7. The electronic device of claim 6, wherein the capacitor charges the auxiliary battery when the capacitor is full.

8. The electronic device of claim 6, wherein the capacitor charges the auxiliary battery when electric power stored in the auxiliary batter is less than a threshold level.

9. An electronic device comprising:
an adapter configured to receive an AC power;
a main battery;
an auxiliary battery; and
an input device comprising a piezoelectric layer, the piezoelectric layer connected to the auxiliary battery, the piezoelectric layer configured to be deformed to generate current to charge the auxiliary battery; and
a controller connected to the adapter, the main battery, and the auxiliary battery, and the controller is configured to control one of the adapter, the main battery, and the auxiliary battery to supply power.

10. The electronic device of claim 9, wherein the piezoelectric layer is made of piezoelectric material.

11. The electronic device of claim 9, wherein the input device further comprises a pressing layer, and the piezoelectric layer is located below the pressing layer.

12. The electronic device of claim 11, wherein the input device is a keyboard, and the pressing layer is keys of the keyboard.

13. The electronic device of claim 11, wherein the input device is a touch screen, and the pressing layer is a screen of the touch screen.

14. The electronic device of claim 11, wherein the input device is a mouse, and the pressing layer is a key of the mouse.

15. The electronic device of claim 9, further comprising a capacitor, wherein the capacitor is connected between the piezoelectric layer and the auxiliary battery, and electric energy generated by the piezoelectric layer is stored in the capacitor, and the capacitor charges the auxiliary battery.

16. The electronic device of claim 15, wherein the capacitor charges the auxiliary battery when the capacitor is full.

17. The electronic device of claim 15, wherein the capacitor charges the auxiliary battery when electric power stored in the auxiliary batter is less than a threshold level.
